(19) United States
(12) Patent Application Publication
(10) Pub. No.: US 2015/0134631 A1
(43) Pub. Date: May 14, 2015

(54) SORT

(71) Applicants: Nachshon Goltz, Toronto (CA); Aleksandar Nikolic, Rushville, NY (US)

(72) Inventors: Nachshon Goltz, Toronto (CA); Aleksandar Nikolic, Rushville, NY (US)

(21) Appl. No.: 14/074,715

(22) Filed: Nov. 8, 2013

(51) Int. Cl. G06F 17/30

(52) U.S. Cl. CPC G06F 17/30864
USPC 707/706

(57) ABSTRACT

The SORT is a learning, professional, interactive, and customizable knowledge search, retrieval, and generation method. The customized nature of each component; the combination of components; the way they are used; they way they are integrated; and the purpose of the knowledge search, retrieval, and generation are what distinguish this innovation from other search methods.

The theoretical basis for the method is the Artificial Medium Laws Theory, consisting of five laws and the perceived psychological dimensions which indicate the hierarchical impact of the medium. This theory was developed by Nachshon Goltz. Medium, in the context of these laws and this description, refers to some form of communication medium. The five laws are:

1. Truth in the medium is context dependent;

2. The higher dimension prevails;

3. A medium with a time dimension determines its usage length;

4. The more dimensions the medium possesses the deeper the user's immersion into a virtual environment; and

5. The user is bound to all the laws

The perceived psychological dimension refers to the interpretation of sensory input of the user. The laws and the perceived psychological dimensions to the medium possesses are intertwined: each artificial medium poses one or more perceived psychological dimensions: picture (example: newspaper), sound (example: radio), sound and moving picture (example: TV), sound, moving picture and time (example: Internet) and sound, moving picture, time and interaction (example: virtual worlds). These dimensions have a hierarchical order, from the weakest (picture or sound) to the strongest (interaction). For example, exposure to a medium with a lower level of dimensions (the sound of the radio) will be less influential to a user than exposure to a medium with a higher dimension (a movie). A perceived psychological dimension can vary in its strength. For example, online interaction through a chat is weaker then online interaction using a video conference.

The key to this perceived psychological dimension is that the input is artificially mediated and each medium provides an interpretation for the user—the interpretation is external to the user. There exist media, such as written text, where the user is the interpreter.

The SORT method evolved from this theory of interconnectivity between users, media, knowledge and the community. The SORT is a method of, among others, performing knowledge searches rather than information searches and it provides a means through which a user can actively participate in obtaining knowledge and generating knowledge through immersion in the virtual community that has high levels of perceived psychological dimensions.

Virtual refers to a very high level of interactivity that a person has with a communication medium, in addition to the other perceived psychological dimensions. A high level of immersion with a medium is achieved where the user has direct interaction with other users as well as with the virtual, i.e. the ability to customize that environment according to the user's wishes.

The SORT virtual communities are distinguishable from a social network. These Virtual communities are community oriented rather than individually oriented and operate in a virtual world setting. The virtual world is a more immersive form of media based on the strength of its interaction dimensions, allowing higher levels of interaction both with other users and with the virtual environment. The interaction is both on an interconnectivity level and on a sensory level. Social networks structure how users interact with other users and with the environment, and customization of the environment is limited; hence the interaction dimension is limited and immersion is weak. Users can post pictures and publish information but they cannot change the environment within the social network, nor can users normally interact in real-time. Within The SORT virtual communities, the interaction and the environment can be customized so as to encompass a level of interaction that is much greater than is possible in an online social network, therefore creating a set of virtual worlds which are much more immersive and powerful than social networks. Based on the laws, the level of interaction will vary with the number of perceived psychological dimensions involved in the virtual community and their degree.

The virtual communities that are a part of the SORT not only involve greater user immersion, but also these communities are built around professional and expert information rather than trivial, social, and commercial information. The communities will be organized in such a manner so that the primary focus is professional knowledge and expert information. The virtual communities are further differentiated from social networks in that the communities may embody some of the social characteristics but the focus of the community is knowledge generation and not social connection or commercial connection. The virtual community encompasses a combination of user questions and both expert and user answers, within a virtual world environment, set out in an interconnected setting.

The virtual community is a collaborative environment where users input information and use information but the community exists to generate knowledge. Community members can include general users but also involve experts who act as knowledge providers and moderators within the community's topic field. Providing knowledge is not limited to the expert, but also involves the other users and members of the community.

The term “professional” within the context of The SORT refers to material which is ordinarily used by members of a profession or trade or expert field.

### Existing Tools

To date, there is no knowledge method online that integrates a knowledge search and knowledge generation into one powerful tool, as does The SORT.

There are several search methods which enable users to find information on the internet. Generally, users will enter textual terms or phrases into a search window, click enter, and be provided with a list of information. The most popular websites (“search engines”) are Google, Bing and Yahoo. All will provide the user with links to web pages that match the search query. Each of these websites provides information from a variety of sources, in a variety of formats, with varying degrees of reliability, authoritativeness, and trustworthiness. These sites also tend to be consumer based and consumer organized rather than expert oriented and knowledge based. The most popular engines may return some kind of knowledge information but are more likely to return results from sites that may have all of the keywords within site text, but often bear no relation to the subject matter being searched for. The Wikipedia post and posts from such sites will likely be near the top of the results returned. Such information may be useful for those seeking introductory material but not for those seeking professional matter. These commonly used search engines also rarely have the capability of “drilling down” into an online database. One option professional users have is to use the above popular search engines to find expert databases, and then perform additional searches to find knowledge content. This becomes tedious as many databases are subject-specific, requiring users to search multiple databases.

Patient users may find the information sought by looking through individual databases but these popular search engines are not tools geared for a fast and extensive search of the professional information available. These search engines are not geared to provide professional knowledge.

Other limitations of current search engines include limited search customization and the result display or organization is not customizable, the search is not a virtual activity, and there is no knowledge community connection.

Another option for professional searches is to use a specialized search engine, such as Infomine. Infomine, allows users to select a variety of search sources, specific content information, subject matter, commercial content, resource type, ranking criteria, and content display and material type. By default, search modifications tend to be limitations and not interaction. The user can limit the subjects searched, or conduct searches organized by author. Infomine is clearly a step above the popular search engines when it comes to finding knowledge. However, Infomine is limited in that its customizations are limited, it is not a learning tool, and Infomine is not a virtual tool. Infomine does not provide a virtual connection with a knowledge community. Most importantly, Infomine does not identify the search topic and does not provide a listing of pre determined databases associated with a user's topic. While it allows the user to choose a topic to search within, it lacks the ability to automatically identify the user's topic of interest based on the search query terms.

Existing tools like Wikipedia may involve user inputs to generate information but the information is not necessarily posted by experts and is not necessarily reliable. The virtual community is further distinguished by the level of interaction involved. Wikipedia and such tools are passive tools that seek responses to posts and not direct, real-time, interaction. The virtual community is an active environment where users can interact with experts, other users and the environment.

### BRIEF DESCRIPTION OF DRAWINGS

FIG. 1: The SORT Process—this diagram shows the general steps involved in the process.

FIG. 2: The SORT Topic Identification—this diagram shows the steps involved in identifying topics based on the keywords entered by the user.

FIG. 3: The SORT Virtual Communities—this diagram identifies the general community structure based on subject matter.

### THE SORT

The SORT is a learning, professional, interactive, and customizable knowledge search, retrieval, and generation method. Some of the components for this knowledge method exist in a remote form but the customized nature of each component; the combination of components; the way they are used; they way they are integrated; and the pinpose of the knowledge search, retrieval, and generation are what distinguish this innovation from other search methods.

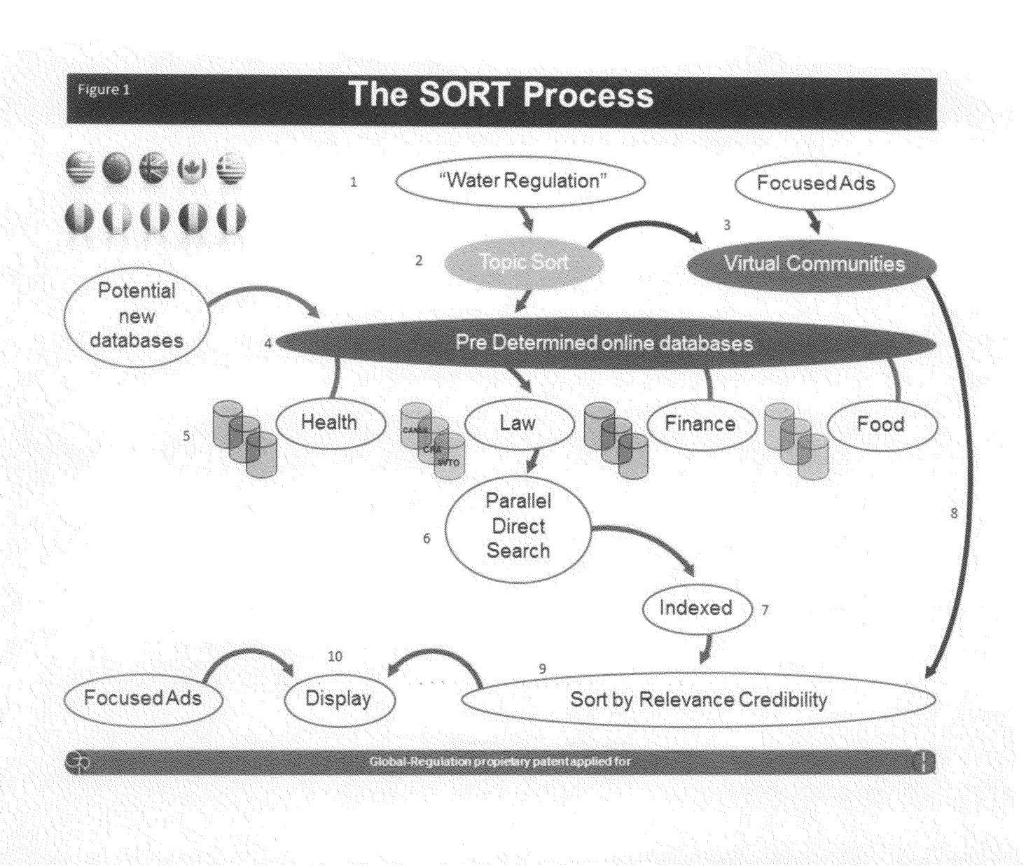

FIG. 1 shows the steps in The SORT Method. The steps are: 1) a user enters a search query, with “water regulation” being shown as an example entry. In 2) the user query is parsed and sorted through the learning system to determine the query topic or topics under which the query falls. The search simultaneously searches a series of predetermined databases and the virtual community. In 3) the query is sent to the relevant topic organized virtual community for response by the community. In 4) the parsed query is sent to the appropriate predetermined database search which is selected based on topics as shown in 5). In 6) the actual search of multiple databases is conducted and the search results are returned to The SORT. In 7) the returned information from the pre-determined databases is indexed and organized for the user. The results from the virtual community search are returned to The SORT in 8). In 9), the returned information from the database search and from the virtual community search is organized by relevance and/or response credibility. In 10) the organized information is displayed to the user.

The first part of the method is the user query.

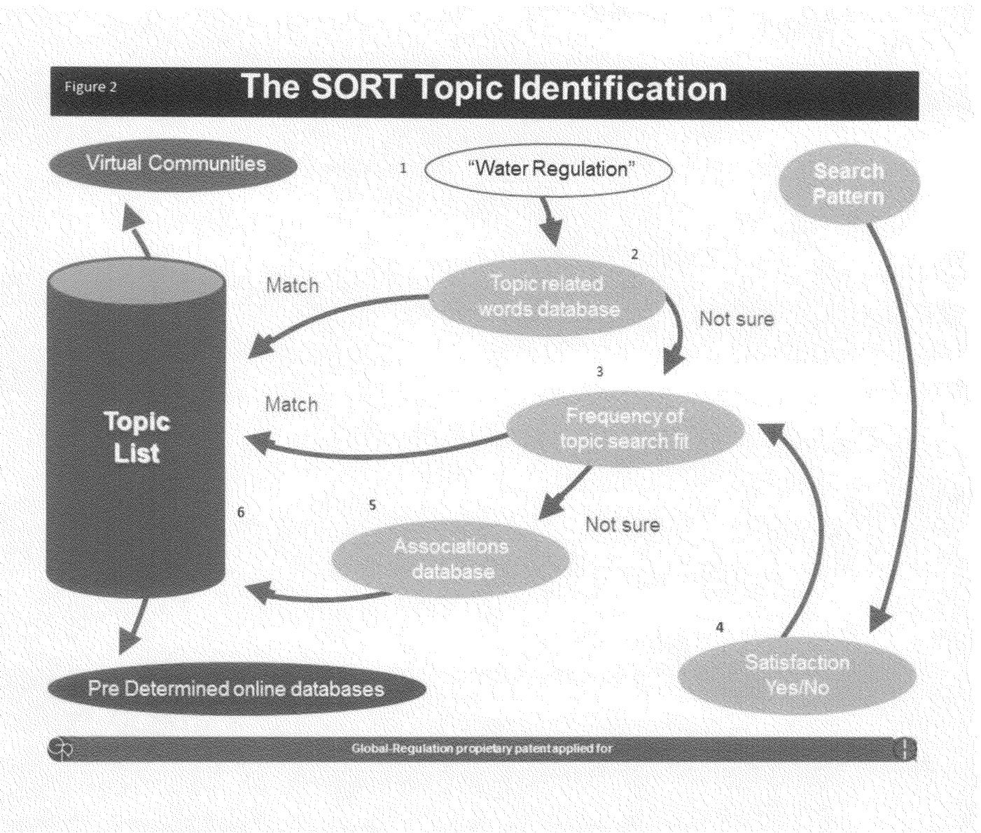

FIG. 2 shows the steps by which The SORT system learns. These are the steps by which The SORT system learns and determines the topic to which is most relevant to the user's query. Step 1) shows a user entry which is sent to the Topic Related Words Database in 2). In 2) the user entry is compared to a database of topic related words/phrases. If there is a perfect (i.e. only one topic) match between the search query and the words/phrases in the Topic Related Words Database, the topic is determined, and the search is then sent to the relevant predetermined databases in 6). If there is no exact match, the query is sent to step 3). In Step 3) the system examines the frequency of the entire search terms in relation to topics searched by users for fit between this query and a specific topic based on user's satisfaction from this match in previous searches. The user satisfaction is determined by search patterns. This fit is determined by frequency of terms and user satisfaction with the topics of the result material as in step 4). If there is no match, the search query is then sent to an association database to examine how the individual terms are tied to the topics list in the association database in 5). Once a topic is chosen, the databases searched are selected based on this topic in step 6). FIG. 2 shows the second part of The SORT method: a customizable, intelligent, selection software integrated into the search engine. This is referred to as the artificial intelligence software. The current trend is for either a key-word search or a semantic search that allows natural language searches to return relevant information. The intelligent software can operate using either search method or it can operate on both keyword and semantic searches. The user can customize which search technique is used. This method requires the user query to be interpreted using either a semantic or keyword oriented search engine or a search engine that interprets queries in both manners.

The software stores key words and associates search parameters with all users and individual user preferences, selecting parameter usage based on general preferences. Users can override search parameters for their personal use or users can fine tune the software to best suit personal needs. The software is customizable so that a user can input the initial parameters and the software will adapt searches based on user results, user preferences, and user habits.

The software can select topics to search, based on the search query terms. As part of the topic selection, the software will determine which internet accessible databases will be searched and also which virtual communities will be searched.

In the third part of The SORT method, the information, as interpreted by the intelligent software, is provided to a search engine which will make a query to the appropriate topic databases and to the appropriate virtual community. As the search engine retrieves information from the databases and the virtual communities, the user can select internet links to connect to the relevant media, both from the selected databases and virtual communities. Alternatively, the user can select connections to enter into the relevant virtual community.

The SORT method can further be customized to allow users to organize results that follow dimensions: i.e. separating text, picture, sound, and video results. Alternatively, users could combine results based on their dimension: i.e. sites with interaction to be the first results displayed.

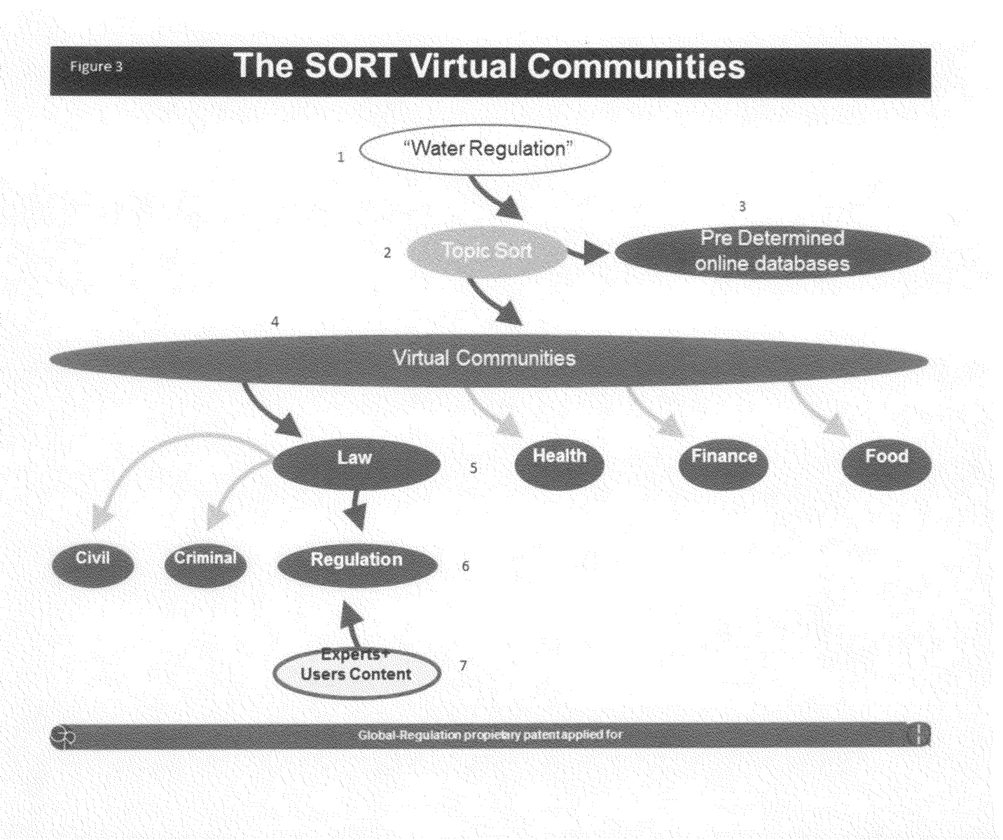

FIG. 3 is an example of the structure of the virtual communities that are searched by The SORT method. For a search query on “water regulation”, 1), the query will be organized by the topic sort, 2). The sorted search is simultaneously transmitted to 3) the predetermined databases and 4) the virtual community. The virtual community of 4) is organized by topics, 5), and subtopics, 6). In addition, Expert content is also gathered in 7).

The fourth part of The SORT method is the virtual community. The virtual community is where there is knowledge exchange. The communities are organized by topics. The fluid and organic nature of knowledge exchange will allow a sub-community to become its own community. Where community topics begin to overlap, a community may break-off to create a cross-community or the communities might merge.

To facilitate the virtual community environment, one embodiment could use a virtual collaboration network such as the IBM Smartcloud Engage. Such a community platform allows for the combination of chats, wilds, video meetings, document collaboration tools, document uploads and downloads, which facilitate collaboration and knowledge generation. Such a platform also allows for considerable user customization.

One embodiment would use a virtual tool that incorporated the interconnection and tools of the IBM Smartcloud but also allows the user to customize his or her environment. Within the community, experts within the field would also answer user questions and share information. The virtual community could act as a publishing platform for expert material. Thus after finding the appropriate community or communities related to the user's search, the user can interact with the community or can become a community member and can contribute to the knowledge development.

Further embodiments might involve a completely virtual environment, more akin to “Second Life”, where users can customize everything about their environment and can interact with other members, but with the environment geared to knowledge contribution and generation.

Another embodiment allows users to perform a search from outside the virtual community, through a more traditional search engine interface but also from within the virtual community, where the interface can be customized.

We claim:

1. An integrated, personalized, and interactive method of gathering and generating knowledge media, using at least one computing device to variously perform the steps of the method; also using a search engine to gather and organize connections to knowledge media; and
also using virtual communities connected to the computing devices and search mechanism for generating knowledge media; and the method comprising: a search query applied to an intelligent software system, where the intelligent software system selects search parameters and search topics to be provided to the search engine; and said search query and search engine parameters and search topics will instruct said search engine to search through a set or subset of predetermined databases, and to simultaneously search through a set or subset of professional topic-specific virtual communities, where the virtual communities are organized by topics; and
where the search engine will return organized and indexed links to knowledge sources and summaries of knowledge media discovered;

2. The method of claim 1 wherein a user can interact with the intelligent software system search parameter selection, through user input, to customize the databases and virtual communities searched, search engine performance, and such parameters comprising: material relevance, search criteria and weights, databases, topics searching, topic sorting, display organization, and information credibility;

3. The method of claim 1 where the intelligent software can learn, analyze, and remember user searching habits, satisfaction patterns, and virtual community involvement; where said user searching habits, satisfaction patters, and virtual community involvement are stored in a storage medium or a storage system for use by the intelligent software for comparison against future searches;

4. The method of claim 1 where the virtual community contains, community member-generated knowledge content which can be searched, wherein knowledge content is comprised of: professional or academic material generated by members, users, and experts; and where the knowledge content exists on media capable of being searched by the search engine;

5. The method of claim 1 where the user can interact with the topic-specific virtual communities, wherein the communities are highly interactive and the interaction comprises:
reading media, viewing media, listening to media, texting, chatting, meeting, discussing, uploading, downloading, exchanging, collaborating, teaching, and learning;

6. The method of claim 1 where the user can adjust search output results to be organized by dimension or dimensions.
